(19) United States
(12) Patent Application Publication
(10) Pub. No.: US 2007/0200016 A1
(43) Pub. Date: Aug. 30, 2007

(54) Bulk cheese shredding system

(76) Inventor: Charles H. Johnson, Westfield, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/362,322

(22) Filed: Feb. 24, 2006

(51) Int. Cl. A47J 43/25

(52) U.S. Cl. 241/93

(57) ABSTRACT

Conveyors to clamp the upper and lower surface of bulk slabs of cheese allowing precise control of feed rates against a drum shredder to promote uniform shred length without the need for cubing of the cheese prior to the shredding process. An anti-caking material may be placed in the drum to treat cheese shreds prior to their discharge.

### CROSS-REFERENCE TO RELATED APPLICATIONS

- - -

### STATEMENT REGARDING FEDERALLY SPONSORED RESEARCH OR DEVELOPMENT

- - -

### BRIEF SUMMARY OF THE INVENTION

The present invention relates to food processing equipment and in particular to an industrial cheese shredding apparatus.

Many consumers prefer the convenience of purchasing cheese in a shredded form. Such “pre-shredded” cheese is easier to serve and to distribute in cooking and eliminates the effort and hazard of shredding cheese at home.

Currently, the bulk shredding of cheese for retail sales may use a commercial disk-type shredding machine. The rotating disk has a surface studded with embossed edges and is used to grate small blocks of cheese (typically two inch cubes) placed in contact with the disk.

The cubes of cheese may tumble in contact with the disk exposing irregular surfaces to the rotating knives and resulting in undesirable variations in the shred length and the production of “fines” which collect unattractively at the bottom of the package. Preparing the cubes of cheese from large blocks of cheese (as much as 640 pounds) is time consuming and costly.

One approach to producing more uniform shred lengths without fines extrudes the cheese through a die plate having oblong holes whose length defines the length of the “shred”. This approach produces extremely uniform shred length but may undesirably modify the texture of the cheeses during the extrusion and the extruded shreds may have an artificial appearance. The change in cheese texture caused by the extrusion and the need to work with small pieces of cheese that may fit in the extrusion machine makes this approach preferable for use with cheese scraps rather than with large blocks of freshly made cheese.

Desirably, a shredding apparatus would be developed that could rapidly shred large blocks of cheese while producing extremely uniform shred lengths.

### SUMMARY OF THE INVENTION

The present invention provides a shredder that may accept slabs cut directly from a large block of cheese. The slabs are supported between conveyor surfaces that prevent tumbling and provide for a controlled feed rate against a rotating shredding drum to produce uniform shred lengths.

The conveyors also allow multiple slabs to be butted against each other for continuous feeding to the drum, and the drum provides a convenient way of introducing anti-caking ingredients into the shreds and allows the production of cheese blends with multiple different types of shredded cheese in predetermined ratios.

Specifically then, the present invention provides a cheese shredder having a drum with a cylindrical shredding surface rotatable about a first axis. A first drive is connected to the drum to rotate the drum about the first axis at a predetermined speed. A first and second conveyor having conveying surfaces opposed about a second axis substantially perpendicular to the first axis are positioned to support opposite sides of a cheese slab for movement of the cheese along the second axis. A second drive moves the cheese contained between the conveyors toward the drum at a second predetermined speed.

It is thus one object of at least one embodiment of the invention to allow direct shredding of cheese slabs cut from large blocks of cheese. The conveyors provide support and controlled feed of such slabs significantly reducing the labor involved in producing shredded cheese from large cheese blocks.

It is another object of at least one embodiment of the invention to provide high quality shreds. The controlled feed and elimination of tumbling provided by the conveyors and the uniform velocity of the surface of the drum against the cheese provides shreds of greater uniformity and with fewer fines.

The shredder may include a speed control communicating with the first and second drives to change the ratio of the predetermined speed of movement of the cheese contained between the first and second conveyor with respect to rotation of the drum.

It is thus another object of at least one embodiment of the invention to provide for controlled feed and drum speed ratios allowing optimal shredding for a variety of different cheeses.

The conveyors may be continuous belts.

Thus it is another object of at least one embodiment of the invention to provide a feed system that provides good support and contact over a broad area of cheese slabs.

The surfaces of the first and second conveyors may be adjustable in separation.

It is thus another object of at least one embodiment of the invention to allow the device to be used with different slab thicknesses and/or combinations of multiple stacked slabs.

The first and second conveyors may provide an exit end adjacent to the drum and an entrance removed from the drum. The entrance end may provide a guide portion allowing later slabs of cheese to be guided into abutment with earlier slabs of cheese for continuous feeding of the drum.

It is thus another object of at least one embodiment of the invention to fully shred each slab without creating unshredded ends which must be removed or which tumble and produce varying cheese shred sizes.

The guide may be an extension of the conveying surface of the first conveyor beyond the end of the second conveyor.

Thus it is an object of at least one embodiment of the invention to provide a guide that provides simple support for location of successive cheese slabs so they may be easily fit into abutment with the earlier cheese slabs.

The first and second conveyors may provide horizontal surfaces.

It is thus another object of at least one embodiment of the invention to provide a system that provides for easy loading of cheese slabs.

The drum may be open at one end and the first axis may be tipped with respect to horizontal so that the grated cheese in the drum passes out the open end with rotation of the drum.

It is thus another object of at least one embodiment of the invention to provide for a controlled passage of the grated cheese collecting in the drum, out of the drum after shredding.

The cheese shredder may include a feeder having an exit opening positioned within the drum for feeding an anti-caking material onto the shredded cheese within the drum. The first axis may be tipped to provide a predetermined minimum dwell time of the grated cheese within the drum before the grated cheese passes out of the drum.

Thus it is another object of at least one embodiment of the invention to eliminate the separate step of tumbling the cheese with an anti-caking material such as may promote breaking of the shreds.

The second drive may turn at least one of the conveyor belts, or alternatively or in addition, a plunger may be positioned to contact a cheese slab positioned between the supporting surfaces at an end removed from the drum to provide for support and pressure against the end.

Thus it is another object of at least one embodiment of the invention to provide a variety of mechanisms for controlling the movement of the cheese slab.

The drum may be no less than 20 inches in length measured along the first axis.

Thus it is another object of at least one embodiment of the invention to provide a shredder that may deal directly with the linear dimension of slabs cut from standard cheese blocks without cubing.

The drum may be supported for rotation at both ends and at least one end of the drum may include a support coaxially within the drum communicating with the circumference of the drum through multiple radial arms. Alternatively or in addition, one end of the drum may include a circumferential support ring supported by multiple rollers.

Thus it is another object of at least one embodiment of the invention to provide a support for a long drum sufficient to shred large slabs without multiple passes and without bending of the drum out of axis while maintaining access to the interior of the drum.

The cheese shredder may further include a fourth and fifth conveyor having conveying surfaces opposed about a third axis perpendicular to the first axis and positionable to support opposite sides of a cheese slab for movement of the cheese slab along the third axis. A third drive may move the cheese contained between the conveyors toward the drum at a third predetermined speed. A controller may communicate with at least one of the second and third drives to control the relative speed of feeding of different types of cheeses placed on the first through fourth conveyors to obtain predetermined cheese mixture ratios.

Thus it is another object of at least one embodiment of the invention to provide a system well adapted to creation of cheese blends.

The second and third axes may be parallel.

Thus it is another object of at least one embodiment of the invention to provide a system for creating cheese blends where both conveyors may be horizontal for easy access.

Alternatively, the present invention may provide a second drum having a cylindrical shredding surface rotatable about a third axis. A third drive may be connected to the drum to rotate the drum about the third axis at a predetermined speed. Fourth and fifth conveyors may be provided having conveying surfaces opposed about a fourth axis substantially perpendicular to the third axis and positionable to support opposite sides of a cheese slab for movement of the cheese slab along the fourth axis. A fourth drive may move the cheese contained between the conveyors toward the second drum at a fourth predetermined speed and a controller may communicate with one of the first through fourth drives to control the relative proportions of grated cheese from the first drum and second drum to obtain a predetermined cheese mixture ratio.

Thus it is another object of at least one embodiment of the invention to provide a system that may provide parallel shredding of even larger volumes of cheese.

The first and third axes may be parallel and the second and fourth axes parallel and, the invention may further include a conveyor positioned under both of at least a portion of the drums to receive cheese therefrom.

Thus it is another object of at least one embodiment of the invention to provide a continuous blending of cheese that does not require batch operations or permit tumbling of the cheese such as may damage the cheese shred.

The present invention enables a method of making shredded cheese in which two types of cheese are stacked across the first axis between the support surfaces of the first and second conveyors. They may then be fed simultaneously into the drum to obtain a mixture of grated cheeses.

It is thus another object of at least one embodiment of the invention to provide a simple method of enforcing particular cheese blend ratios.

These particular objects and advantages may apply to only some embodiments falling within the claims and thus do not define the scope of the invention.

### BRIEF DESCRIPTION OF THE DRAWINGS

FIG. 1 is a perspective view of a first embodiment of the shredder of the present invention showing opposed conveyors for moving a slab of cheese against a rotating shredder drum under the control of separate drives;

FIG. 2 is a side elevational view of the shredder of FIG. 1 showing the extension of the lower conveyor to provide a guide lip allowing successive slabs of cheese to be abutted against each other for continuous shredding;

FIG. 3 is a cross-sectional, elevational view along lines 3-3 of FIG. 1 showing a tipping of the axis of the drum, its support by rollers, and a feeder for introducing anti-caking ingredients into the drum;

FIG. 4 is a top plan view of two shredders per FIG. 1 arrayed along a conveyor belt for producing higher volumes of shredding and/or blended cheeses;

FIG. 5 is a view similar to that of FIG. 2 showing the stacking of two cheese slabs of different cheese types to produce blended grated cheese;

FIG. 6 is a figure similar to that of FIG. 5 of an alternative embodiment of the shredder of the present invention using opposed horizontal conveyor belts; and

FIG. 7 is a figure similar to that of FIGS. 5, 6 and 7 of an embodiment of the present invention in which direct drive of the conveyors is augmented or replaced by a piston system.

### DETAILED DESCRIPTION OF THE PREFERRED EMBODIMENT

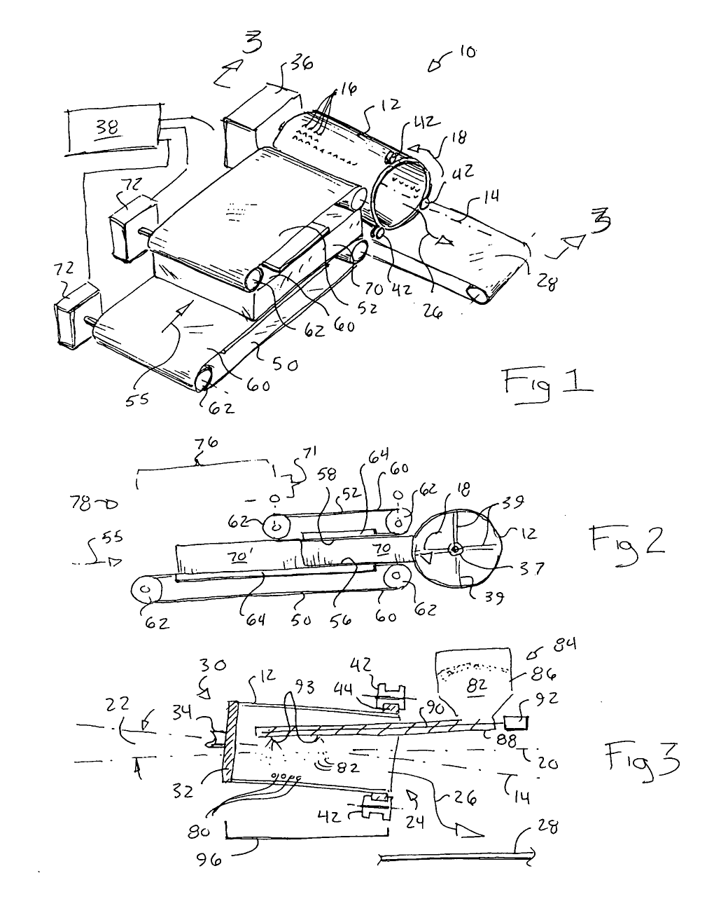

Referring now to FIG. 1, a cheese shredder 10 of the present invention employs a shredder drum 12 having a cylindrical shredding surface disposed along a drum axis 14. The drum 12 may, for example, be a stainless steel tube with the knife embossments 16 formed therein. The drum 12 will typically have a length along axis 14 of more than 20 inches and will have knife embossments 16 extending no less than this length so that a slab cut from a standard 640 pound block of cheese may be shredded in one pass when pressed against the side of the drum 12.

Each knife embossment 16 may be formed from a hole cut through the surface of the drum 12. A trailing edge of each hole is pressed outward and sharpened so that with forward rotation 18 of the drum 12, the edge will cut into cheese pressed against the drum 12 to cut shreds from the cheese. Knife embossments 16 of this type are well known in the art.

Referring now also to FIG. 3, the drum axis 14 may be tipped slightly with respect to a horizontal axis 20 by a tip angle 22. This tipping is such that an open end 24 of the drum 12 slants downward to let shreds 80, passing through the knife embossments 16 of the drum 12, fall from the drum 12 in a trajectory 26 onto a conveyor belt 28 or other receiving surface.

Referring to FIGS. 1, 2, and 3, a second end 30 of the drum 12, opposite end 24, may be attached by a support 32 to a shaft 34 of a motor drive 36. Support 32 may be a continuous plate equal in diameter to the diameter of the drum 12 and attached thereto or may be a spider support as shown in FIG. 2 in which a central hub 37 attached to shaft 34 communicates with the periphery of the drum 12 through extension arms 39 extending like spokes radially between the hub 37 and the outer wall of the drum 12. This latter configuration provides an opening into the drum and may be used both at ends 30 and 24.

Alternatively as shown in FIGS. 1 and 3, the discharge end 24 of the drum 12 may be supported by rollers 42 engaging a reinforcement ring 44 passing circumferentially along the outer lip of the drum 12 at end 24. In either of these ways, the drum 12 may be supported rigidly for rotation while resisting radial forces imposed by pressure of cheese pressed against the outside of the drum 12.

Referring again to FIGS. 1 and 2, conveyors 50 and 52 may be placed along a conveyor axis 55 generally perpendicular to axis 14 so that support surfaces 56 of conveyor 50 and support surface 58 of conveyor 52 are opposed and separated about the axis 55. In a preferred embodiment, conveyors 50 and 52 provide continuous belts 60 passing around end rollers 62. The end rollers 62 may turn so that the support surfaces 56 and 58 (provided by the belts 60) move in unison while supporting the upper and lower surface of a cheese slab 70 cut from a standard 640 pound block. Such slabs 70 will typically be twenty-two inches wide by twenty-eight inches long by two inches high.

The rollers 62 of conveyor 52 may be adjusted in separation from the rollers 62 of conveyor 54 to the height of the cheese slab 70. Belts 60 may pass outside of support plates 64 on each of the conveyors 52 and 54 so that a cheese slab 70 placed between the conveyors 50 and 52 is firmly supported and gripped as it moves along axis 55 with turning of the rollers 62.

As shown in FIG. 1, one or more of the rollers 62 of conveyors 50 and 52 may be connected to a motor drive 72. The motor drive 72 and the motor drive 36, may communicate with motor controller 38 which may electronically or mechanically control the relative and/or absolute speeds of the drum 12 and roller 62. The motor drives 72 and 36 may have separate electrical motors electronically controlled in speed or may be a single motor driving multiple shafts through mechanical speed control mechanisms.

Referring again to FIGS. 2 and 3, the cheese slab 70 as held securely between the conveyors 50 and 52 may thus be moved controllably against the drum 12 for consistent feed rate with respect to the rotational speed of the drum 12. In this way, the feed rate for a given drum speed may be readily changed, for example, for different types of cheese or different desired loadings and the absolute drum speed and feed rate may also be freely varied to provide for optimal rates of shredding of a variety of different types of cheese. Because the cheese slab 70 is controllably held and fed, tumbling of cheese such as may produce inconsistent shreds is prevented.

Referring now to FIG. 2, conveyor 50 may extend from a point adjacent to the drum 12 to a distance away from the drum 12 greater than the extension of the conveyor 52 from a point near the drum 12 to its furthest distance away from the drum 12. This difference in length 76 provides a ledge 78 on which a subsequent cheese slab 70′ may be placed while cheese slab 70 is being shredded against the drum 12. Cheese slabs 70′ and 70 may in this way be abutted with or without stopping the machine so that the tail end of slab 70 is supported and urged forward by the front end of slab 70′.

Referring now to FIG. 3, shreds 80 from cheese slab 70 will fall into the interior of the drum 12 and with rotation of the drum 12 will move toward discharge end 24 of the drum 12 onto conveyor belt 28. The average time that the shreds 80 are in the drum (the dwell time) is adjusted by adjusting the tip angle 22 or other means so that the shreds 80 can be treated with an anti-caking material 82 provided by a dispenser system 84.

The dispenser system 84 includes a hopper 86 for receiving an anti-caking powder and an auger delivery tube 88 having a contained auger 90 rotated by a motor 92 to move the anti-caking material 82 through the delivery tube 88. Orifices 93 placed in the delivery tube 88 on its portion within the drum 12 are dispersed into the volume of the drum 12.

A fine collection tray 96 may be positioned beneath the drum 12 to collect material falling out of the drum 12 through the open wall rather than out the discharge end 24 preventing fines and excess anti-caking material 82 from dropping onto the conveyor belt 28.

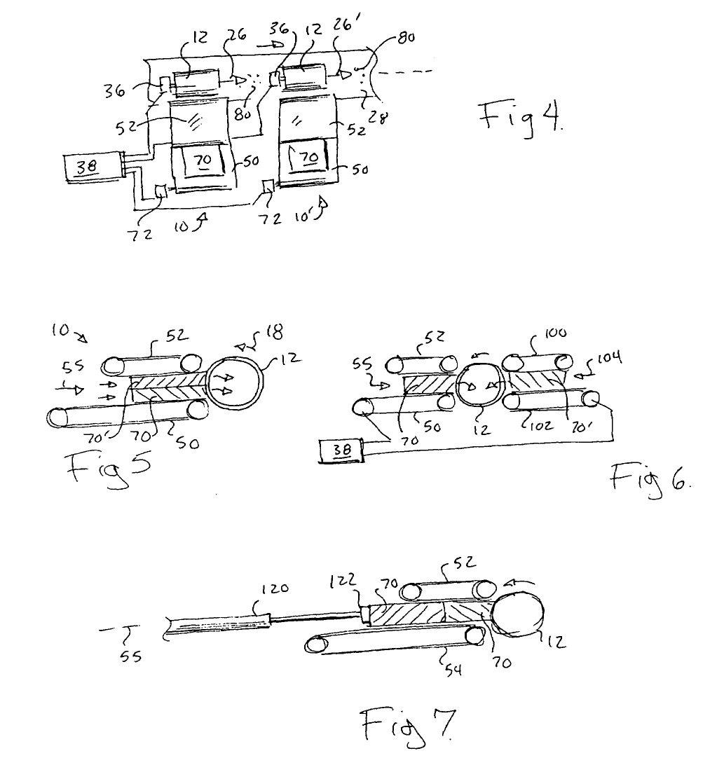

Referring now to FIG. 4, two or more cheese shredders 10 and 10′ may be arranged with axes 14 lying in a common vertical plane along a conveyor belt 28. Cheese slabs 70 fed against the drums 12 of each of the shredders 10 and 10′ will discharge along parallel trajectories 26 and 26′ over different portions of the conveyor belt 28 as the conveyor belt 28 moves beneath them generally along the axes 14. The shredders 10 thus readily adapt to parallel operation for increased shredding volume and/or to allow continuous loading of different of cheese slabs 70 onto alternating shredders 10 and 10′ for efficient use. Alternatively, different cheese slabs 70 may be placed on each of the shredders 10 and 10′ to produce different shreds 80. These different shreds 80 are combined on the surface of the conveyor belt 28 as it passes beneath shredders 10 and 10′ and without the need for tumbling or other time-consuming mixing processes that could break the shreds or produce additional fines.

The motor controller 38 may separately control both the feed speeds of the shredders 10 and 10′ through drives 72 and the total shred rate by simultaneous control of drives 72 and 36. In this way, different types of cheeses may be given the optimal feed rates by controlling the ratio of speeds of the drum 12 and the conveyor 50 and/or the mixture ratio of different cheeses may be independently controlled.

Referring now to FIG. 5, a single shredder 10 may also produce mixtures of different types of shredded cheese by stacking cheese slabs 70 and 70′ of two different types, one on top of another, on conveyor 50 and making the appropriate adjustment in the separations between conveyor 50 and conveyor 52. The ratio of the thicknesses (or cross-sectional areas) of the cheese slabs 70 and 70′ will control the ratio of the cheese types in the mixture.

Referring now to FIG. 6, in an alternative embodiment, additional upper conveyor 100 and lower conveyor 102 corresponding respectively to conveyors 52 and 50 may be placed on an opposite side of the drum 12 to feed along an axis 104 aligned with axis 55 so that cheese slabs 70 and 70′ move in opposite directions along a single axis toward the drum 12. In this embodiment, the feed speeds of the conveyors 52 and 50 may differ from the feed speed of the conveyor 102 and 100 allowing control of the mixture ratio or optimal feed speeds but requiring only a single drum 12.

Referring now to FIG. 7, the force provided by conveyor 52 or 54 in moving cheese slabs 70 along the axis 55 may be augmented or replaced by the use of a ram 120, for example, using a pneumatic or hydraulic cylinder, pressing a plunger head 122 with a constant force against a vertical trailing surface of slab 70 to move slab 70 toward the drum 12. Here the conveyors 52 and 54 may provide simply a support system for firmly clamping the cheese slab 70 and preventing it from tumbling during the shredding process or may provide additional force on the cheese lab 70.

It is specifically intended that the present invention not be limited to the embodiments and illustrations contained herein, but include modified forms of those embodiments including portions of the embodiments and combinations of elements of different embodiments as come within the scope of the following claims.

I claim:

1. A cheese shredder comprising:
a drum having a cylindrical shredding surface rotatable about a first axis;
a first drive connected to the drum to rotate the drum about the first axis at a predetermined speed;
first and second conveyors having conveying surfaces opposed about a second axis substantially perpendicular to the first axis and positionable to support opposite sides of a cheese slab for movement of the cheese slab along the second axis; and
a second drive to move cheese contained between the conveyors toward the drum at a second predetermined speed.

2. The cheese shredder of claim 1 further including a speed controller communicating with the first and second drive to change a ratio of the predetermined speed of movement of cheese contained between the first and second conveyor with respect to rotation speed of the drum.

3. The cheese shredder of claim 1 wherein the conveyors are continuous belts.

4. The cheese shredder of claim 3 wherein the second drive moves the belt of at least one of the conveyors.

5. The cheese shredder of claim 1 including an adjustable support attached to at least one of the first and second conveyors to adjust the separation between the conveying surfaces.

6. The cheese shredder of claim 1 wherein the first and second conveyors provide an exit end adjacent to the drum and an entrance end removed from the drum, the entrance end providing a guide portion allowing later slabs of cheese to be guided into abutment with earlier slabs of cheese for continuous feeding into the drum.

7. The cheese shredder of claim 6 guide portion is an extension of the conveying surface of the first conveyor beyond the end of the second conveyor.

8. The cheese shredder of claim 1 wherein the first and second conveyors provide substantially horizontal conveying surfaces.

9. The cheese shredder of claim 1 wherein the drum is open at at least one end and wherein the first axis is tipped with respect to horizontal so that grated cheese in the drum passes out an open end with rotation of the drum.

10. The cheese shredder of claim 9 further including a feeder having an exit opening positioned within the drum for feeding an anti-caking material onto shredded cheese within the drum.

11. The cheese shredder of claim 10 wherein the first axis is tipped to provide a predetermined minimum dwell time of grated cheese within the drum before grated cheese passes out of the drum.

12. The cheese shredder of claim 1 wherein the second drive is a plunger positioned to contact a cheese slab positioned between the conveying surfaces at an end removed from the drum to provide support for and pressure against the end.

13. The cheese shredder of claim 1 wherein the drum is no less than 20 inches in length measured along the first axis.

14. The cheese shredder of claim 1 wherein the drum is supported for rotation at opposite ends.

15. The cheese shredder of claim 1 wherein at least one end of the drum includes a support coaxially within the drum communicating with a circumference of the drum through multiple radial arms.

16. The cheese shredder of claim 1 wherein at least one end of the drum includes a circumferential support ring supported by multiple rollers.

17. The cheese shredder of claim 1 further including:
fourth and fifth conveyors having conveying surfaces opposed about a third axis substantially perpendicular to the first axis and positionable to support opposite sides of a cheese slab for movement of the cheese slab along the third axis; and
a third drive to move cheese contained between the conveyors toward the drum at a third predetermined speed; and
a controller communicating with at least one of the second and third drives to control a relative speed of feeding different types of cheese placed between the first and second conveyors and third and fourth conveyors to obtain a predetermined cheese mixture ratio.

18. The cheese shredder of claim 1 wherein the second and third axes are parallel.

19. The cheese shredder of claim 1 further including:
a second drum having a cylindrical shredding surface rotatable about a third axis;
a third drive connected to the drum to rotate the drum about the third axis at a third predetermined speed;
fourth and fifth conveyors having conveying surfaces opposed about a fourth axis substantially perpendicular to the third axis and positionable to support opposite sides of a cheese slab for movement of the cheese slab along the fourth axis;
a fourth drive moves cheese contained between the conveyors toward the second drum at a fourth predetermined speed; and
a controller communicating with at least one of the first through fourth drives to control the relative proportions of grated cheese from first drum and second drum to obtain a predetermined cheese mixture ratio.

20. The cheese shredder of claim 1 wherein the first and third axes are parallel and the second and fourth axis are parallel and further including a conveyor positioned under both of at least a portion of the drum to receive cheese therefrom.

21. A method of shredding cheese employing a drum having a cylindrical shredding surface rotatable about a first axis, a first drive connected to the drum to rotate the drum about the first axis at a predetermined speed, first and second conveyors having conveying surfaces opposed about a second axis substantially perpendicular to the first axis and positionable to support opposite sides of a cheese slab for movement of the cheese slab along the second axis; and a second drive to move cheese contained between the conveyors toward the drum at a second predetermined speed, the method comprising the steps of:
(a) stacking a first and second type of cheese across the first axis between the support surfaces; and
(b) feeding the first and second type of cheese simultaneously into the drum to obtain a mixture of grated cheeses.
